(19) United States
(12) Patent Application Publication
(10) Pub. No.: US 2015/0006417 A1
(43) Pub. Date: Jan. 1, 2015

(54) SYSTEM AND METHOD FOR SCREENING APPLICANTS

(71) Applicant: LinkedIn Corporation, Mountain View, CA (US)

(72) Inventor: Akash Agrawal, Gurgaon (IN)

(21) Appl. No.: 13/929,160

(22) Filed: Jun. 27, 2013

(51) Int. Cl. G06Q 10/10

(52) U.S. Cl. CPC G06Q 10/1053
USPC 705/321

(57) ABSTRACT

A system and method are provided for screening applicants for a position (e.g., a job, an internship, a volunteer position). A recruiter responsible for the position identifies a functional area of the position and assembles or identifies a pool of questions regarding basic or core knowledge of that area, which may be divided into multiple levels of difficulty. When an applicant applies for the position, he or she is presented a test of some number of questions from the pool, possibly before his or her application is provided to the recruiter. The applicant completes the test and the results are provided to the recruiter, possibly with associated information (e.g., how much time the applicant needed to finish, a percentage correct, comparison of the applicant's results with other applicants' results).

### BACKGROUND

This invention relates to the field of computer systems. More particularly, a system and methods are provided for screening an applicant for a job or other competitive position.

The hiring process at many organizations entails sorting through myriad applications for a single position. Typically, a recruiter will attempt to quickly screen applicants and their applications in order to find candidates that appear to be sufficiently qualified to seriously consider for a position.

This screening process may involve a short personal interaction between the recruiter and an applicant, during which time the recruiter must determine whether to place the applicant on a “shortlist” of candidates to be invited to a full interview. Alternatively, the screening process may consist of the recruiter's review of a few documents provided by the applicant (e.g., job application, résumé).

Because only a limited number of applicants will be shortlisted, and because the recruiter may not have the time or means to determine whether a particular applicant possesses the necessary basic knowledge for a given position, some applicants will be shortlisted that should not be further considered for the position and, conversely, some applicants that would likely do well in the position may not be shortlisted.

In the former scenario, time and resources of the organization and the organization's employees (e.g., recruiter, interviewers) are wasted considering someone who does not have even the basic level of knowledge necessary for the position. In the latter scenario, the recruiter's time constraints may cause a quality candidate to be overlooked.

### DESCRIPTION OF THE FIGURES

FIG. 1 is a block diagram of a system for automatically screening applicants for shortlisting, in accordance with some embodiments of the invention.

FIG. 2 is a flow chart illustrating a method of automatically screening an applicant for a shortlist, in accordance with some embodiments of the invention.

FIGS. 3A-B illustrate an interface employed by a recruiter or other organization representative to configure a pool of questions, in accordance with some embodiments of the invention.

FIG. 3C illustrates an interface employed by a recruiter or other organization representative to define parameters of a position offered by the organization, in accordance with some embodiments of the invention.

FIG. 3D illustrates a testing interface presented to a position applicant, in accordance with some embodiments of the invention.

FIG. 3E illustrates an interface for reporting an applicant's test results to a recruiter or other organization representative, in accordance with some embodiments of the invention.

FIG. 4 is a block diagram of an apparatus for automatically screening an applicant, in accordance with some embodiments of the invention.

### DETAILED DESCRIPTION

The following description is presented to enable any person skilled in the art to make and use the invention. Various modifications to the disclosed embodiments will be readily apparent to those skilled in the art, and the general principles defined herein may be applied to other embodiments and applications without departing from the scope of the present invention. Thus, the present invention is not intended to be limited to the embodiments shown.

In some embodiments of the invention, a system and methods are provided for automatically shortlisting an applicant for a position (e.g., a job, a volunteer position). In these embodiments, when an applicant submits an application, he is automatically supplied with a test of one or more questions designed to test his basic knowledge of subject matter associated with a functional area or field of the position (e.g., computer science, accounting, marketing, sales). His responses to the test, and/or his score, are provided to a recruiter who makes a decision whether to shortlist the applicant, based on the responses to the questions and possibly other information (e.g., a job application, a résumé). Alternatively, the system may automatically shortlist him in some circumstances.

The questions may be selected randomly from a pool of questions associated with a particular role, position or type of position (e.g., software engineer, accountant, marketer, sales associate). A pool may have any number of questions, of the same or different difficulties. If populated with questions of varying difficulty, the pool may be used for a range of positions—from an entry-level position to a medium-level position, for example.

A recruiter may specify a number of questions to be posed to an applicant for a position, the difficulty level(s) of questions to select and can opt to make the questions mandatory or optional. In some implementations, an applicant who opts not to answer the questions may be assumed to not be very interested in the position and may be automatically excluded from the shortlist and/or his application may not be processed further.

When provided with an applicant's results of a test posed to him, a recruiter (or other representative of an organization) may be informed of the amount of time the applicant took to complete the questions, his score, the average score of some or all applicants who were tested and/or who were asked the same questions, etc. The recruiter may manually decide whether to shortlist a particular applicant, or may allow the system to make the decision based on the applicant's responses and/or other criteria.

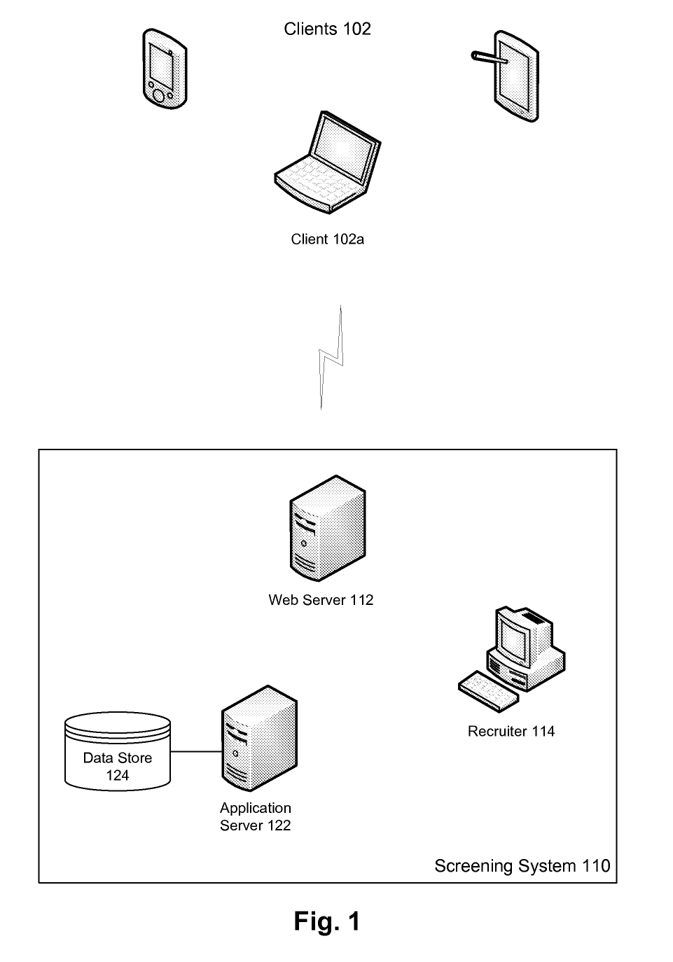

FIG. 1 is a block diagram of a system for automatically screening applicants for shortlisting, according to some embodiments of the invention. In these embodiments, applicants for positions (e.g., jobs, roles, volunteer positions, internships) managed by or available at an organization associated with screening system 110 connect to the system with a client device 102 (e.g., client 102a), which may be a mobile or stationary computing device, a personal digital assistant, a smart phone or a similar device. Clients 102 operate web browsers to interact with system 110.

In some implementations, screening system 110 is part of an organization advertising one or more positions for which applications are accepted. in some other implementations, screening system 110 may be operated in affiliation or partnership with one or more organizations that have positions available and that accept applications via screening system 110.

System 110 includes a front-end component such as one or more web servers 112, a back-end component such as one or more application servers 122, and one or more recruiter stations 114. Application server(s) 122 are coupled to data store 124. Interaction with an applicant to present a test, receive the results and provide those results to a recruiter may be driven primarily by application server 122, via web server 112. Thus, one or more pools of questions may be stored in data store 124. The number of pools stored may depend on the types and/or number of positions for which applications are screened via screening system 110.

In some embodiments of the invention, screening system 110 is part of a professional network site or professional social networking site, such as a site operated by LinkedIn® Corporation, which promotes professional interactions and formation and maintenance of professional relationships. Thus, an organization that operates or is associated with system 110 may maintain information regarding many companies, corporations and/or other entities that have positions open for application, including the organization itself.

Screening system 110 may therefore be part of or coupled to a larger system that stores professional information regarding individuals (possibly including applicants for positions advertised via the system), to include skills, endorsements of those skills, associations with other individuals and/or organizations, education, training, work experience, job title(s), professional interests and/or other attributes, and that facilitates creation of new professional and/or personal relationships.

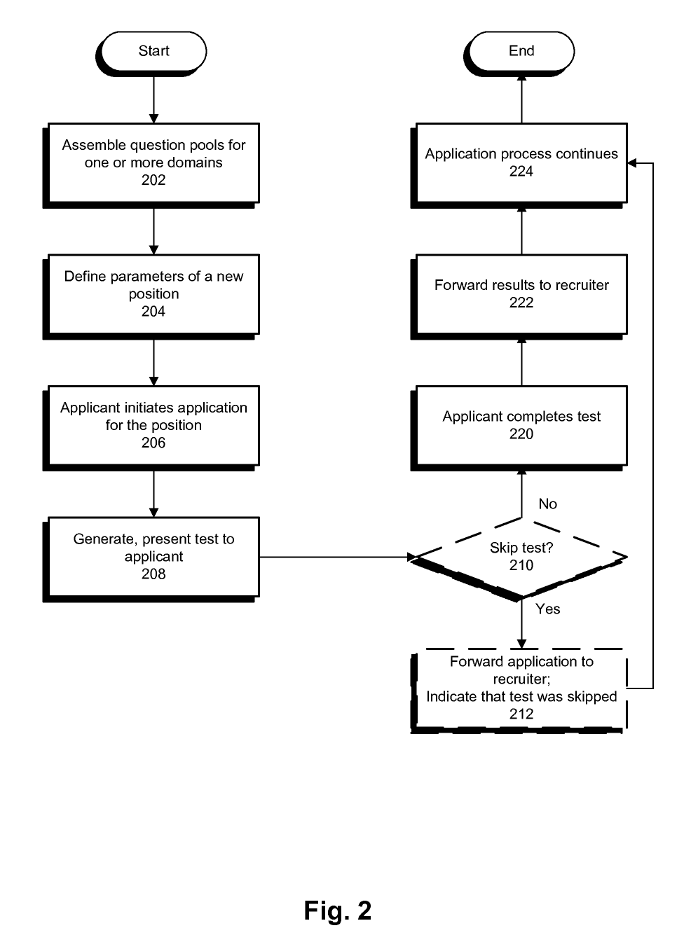

FIG. 2 is a flow chart illustrating a method of automatically screening an applicant for consideration for a position, according to some embodiments of the invention. The illustrated method is implemented by or on behalf of an organization accepting applications for the position.

In operation 202, one or more question pools are assembled, each of which is associated with a different domain or functional area (e.g., accounting, marketing, sales, software engineering, electrical engineering). The questions are configured to probe an applicant's basic familiarity with core concepts of the associated domain or functional area.

For example, questions for the accounting domain might test an applicant's familiarity with GAAP (Generally Accepted Accounting Principles), questions for the marketing domain might probe an applicant's understanding of the 4 Ps (Product, Price, Place, Promotion), questions for the software engineering domain might test an applicant's knowledge of basic data structures and/or programming principles, etc. Questions for a particular domain might be configured by a recruiter, by a manager or expert in that domain or some other person, and/or might be extracted from text books, industry literature and/or other sources.

Questions within a given pool may or may not be segregated by difficulty. Any number of difficulty levels may be defined, to allow a recruiter or other representative greater flexibility in tailoring the screening process to a particular position. In some implementations, questions are all multiple-choice. In other implementations, questions may require short written answers, matching and/or may have other formats.

Preferably, the number of questions assembled into a pool will be great enough to diminish the frequency with which the same set of questions will be posed to applicants for a given position. Thus, in some embodiments, dozens of questions may be assembled. The greater number of questions to be posed to a given applicant, the greater the number of questions may be assembled. Operation 202 may be re-visited at various times to add new questions, remove stale or problematic (e.g., unclear) questions, re-word questions, create a new pool, etc.

In operation 204, a recruiter defines one or more parameters of a new (or recurring) position for which applications are to be accepted. One parameter identifies (e.g., by domain) the pool of questions from which questions are to be drawn and presented to an applicant.

Other parameters may identify a number of questions (an exact number, an average, a minimum, a maximum) to pose to an applicant, level(s) of difficulty (especially if the associated pool includes questions within multiple levels of difficulty), an indication whether the test is mandatory or optional, a maximum time to allow for the test, identities of questions to specifically include (or exclude) in a test, and/or others. The recruiter may also add a question (for this position and/or the pool), change the answers offered for a multiple-choice question, change the wording of an existing question, etc.

For a recurring position, or for multiple positions in one domain or functional area, a template may be defined to provide default options for the various parameters, but may be overridden on a case-by-case basis each time the position is opened for application.

After defining the necessary parameters, the recruiter releases or posts the position such that it can be applied for via a screening system such as screening system 110 of FIG. 1

In operation 206, an applicant applies for the position via a connection with the application screening system or a system or site connected to the screening system. For example, she might operate a client device 102 of FIG. 1 to connect to a front-end component of screening system 110 (e.g., web server 112). After she is connected, the applicant selects or navigates to an option to apply for the position. As another example, the applicant may observe an announcement or advertisement regarding the position on a site associated with the organization that is offering the position, or on a 3^{rd} party site, and may select or click on the announcement to be redirected to the screening system or site.

As part of operation 206, the applicant may identify the position for which she is applying, may complete an on-line application form, and may upload a résumé and/or other documents (e.g., a letter of recommendation, an unofficial school transcript). Identifying or selecting the desired position may involve clicking on a button, selecting the position from a menu, or some other action. At this point of the application process, the applicant may be unaware that the process of applying for the selected position includes taking a test.

In operation 208, the applicant is presented with a set of questions randomly drawn from the pool identified by the recruiter and matching any relevant parameters (e.g., number of questions, difficulty level(s)). This may require the applicant to be redirected to a testing portion or page of the screening system.

In optional operation 210, the applicant may be able to skip the test (e.g., if the recruiter did not mark the test as mandatory when defining parameters of the position). If the applicant is able to forego the test, and does, the method continues at operation 212; otherwise the method advances to operation 220.

In operation 212, the applicant's application and any other material she submitted is forwarded to the recruiter or other representative of the organization responsible for reviewing applicants and applications for the position. In some alternative embodiments, the applicant may be penalized for not taking the test, because avoiding the test may indicate that she isn't very enthusiastic about the position. For example, her application may only be reviewed after all applications submitted by applicants who opted to take the test. After operation 212, the method advances to operation 224 or, alternatively, ends.

In operation 220, the applicant takes the test. The test may be designed to require only a short period of time (e.g., two minutes, five minutes), or may be more substantial (e.g., ten minutes, fifteen minutes). As indicated above, in different embodiments of the invention, questions may take different forms (e.g., multiple-choice, short answer, matching). Also, she may be asked questions of uniform difficulty or of multiple levels of difficulty (as judged by a member of the functional area and/or a recruiter, for example), depending on parameters defined by the recruiter.

In some implementations, a question may entail solution of a problem within the functional area of the position. For example, an applicant for a software engineering or application developer position may be asked to code a simple sort algorithm, an applicant for an accounting position may be asked to identify an error in a balance sheet or other financial document, an applicant for an electrical engineering position may be asked to identify an error in a digital or analog circuit, etc.

In operation 222, a testing module of the screening system forwards to the responsible recruiter or representative the results of the applicant's test, which may include her answers (and the questions) and/or her score (e.g., as a percentage, as a raw number or ratio). The testing module also reports the length of time that elapsed while she took the test.

In some embodiments of the invention, average or median scores of other test-takers are also reported, so that the recruiter can easily compare this applicant's performance with other applicants. These data may be per question and/or may reflect performances of other applicants given exactly the same set of questions. Yet further, data may be provided comparing this applicant's performance with other applicants considered similar in some respect.

For example, in an embodiment of the invention in which the screening system is operated by a professional networking site such as that offered by LinkedIn® Corporation, the system may have access to various attributes of the applicant (e.g., education, age, employment status, employer, current job, experience, skills). One or more attributes of this applicant may be cross-referenced with those of other applicants and used to assemble comparisons with applicants matching any number of attributes.

In operation 224, the application process continues. This may entail review of the applicant's application, consideration for shortlisting for further discussion and/or a round of interviews, consideration for other positions not applied for, etc.

In some embodiments of the invention, if the applicant completes the test and obtains a threshold score (e.g., 90%, 100%), she may be automatically shortlisted (possibly subject to confirmation by a recruiter). After operation 224, the illustrated method ends.

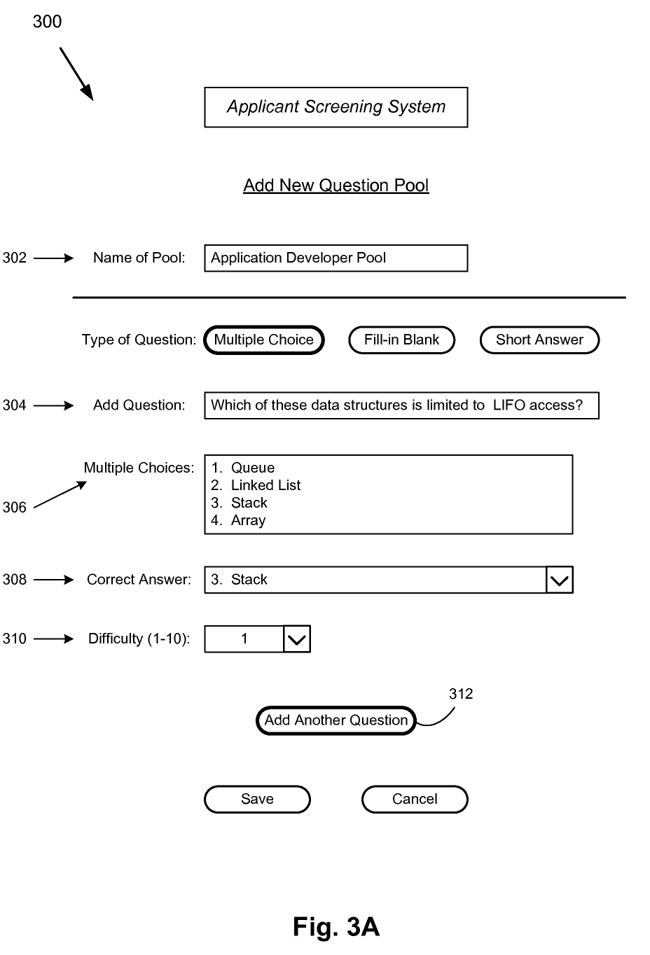

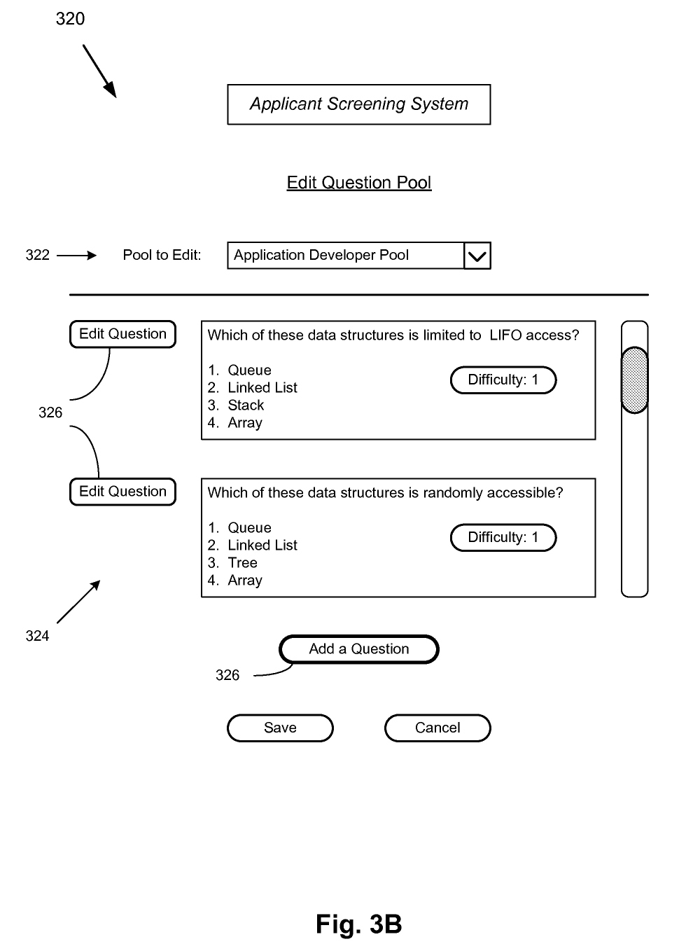

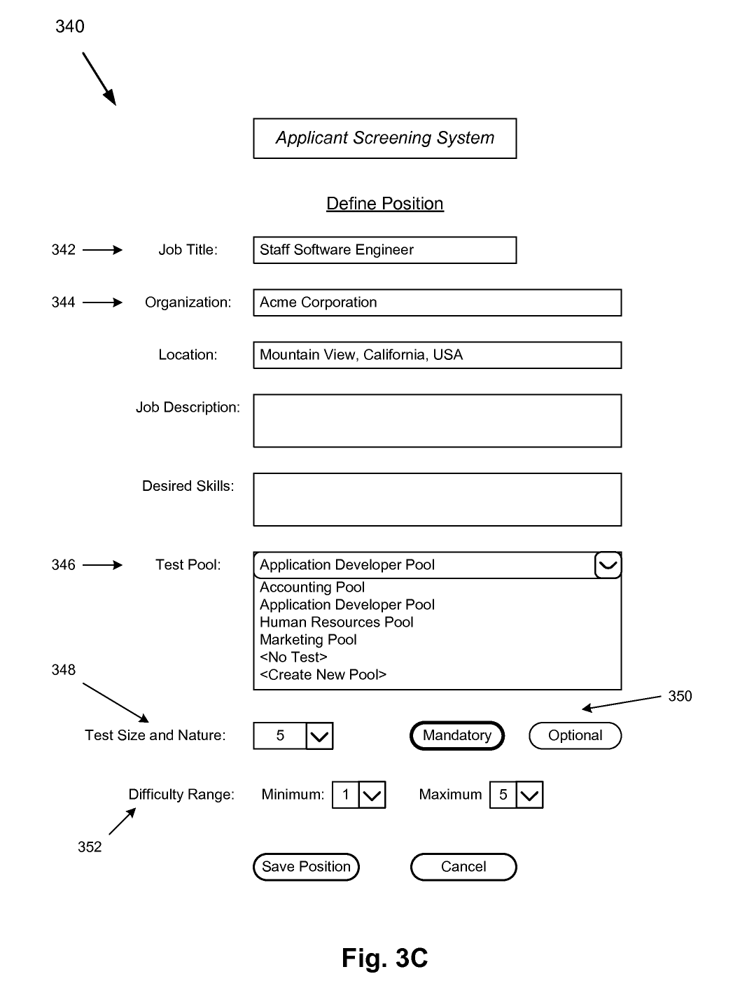

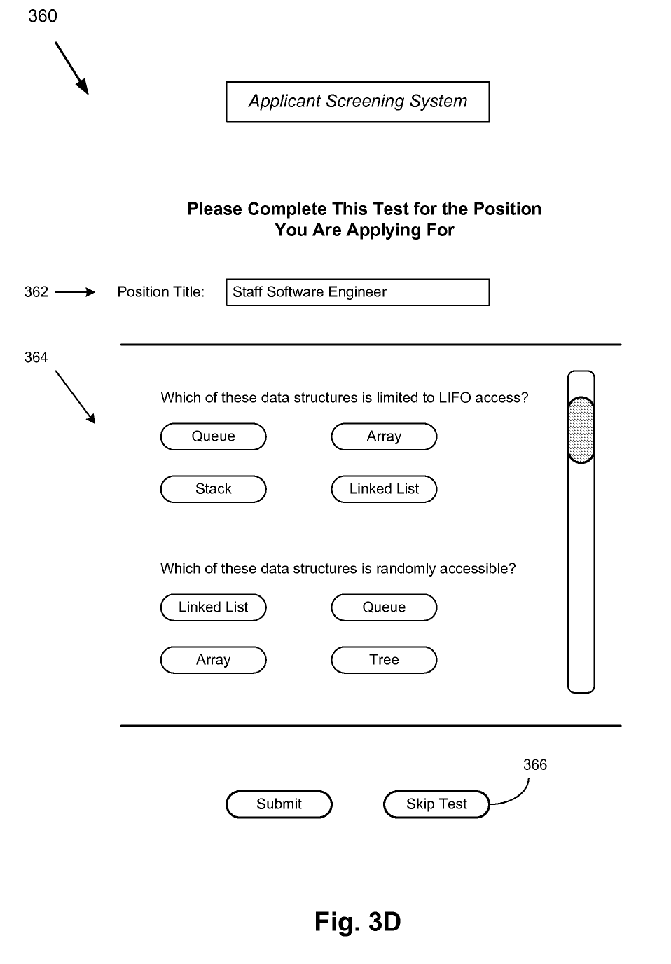

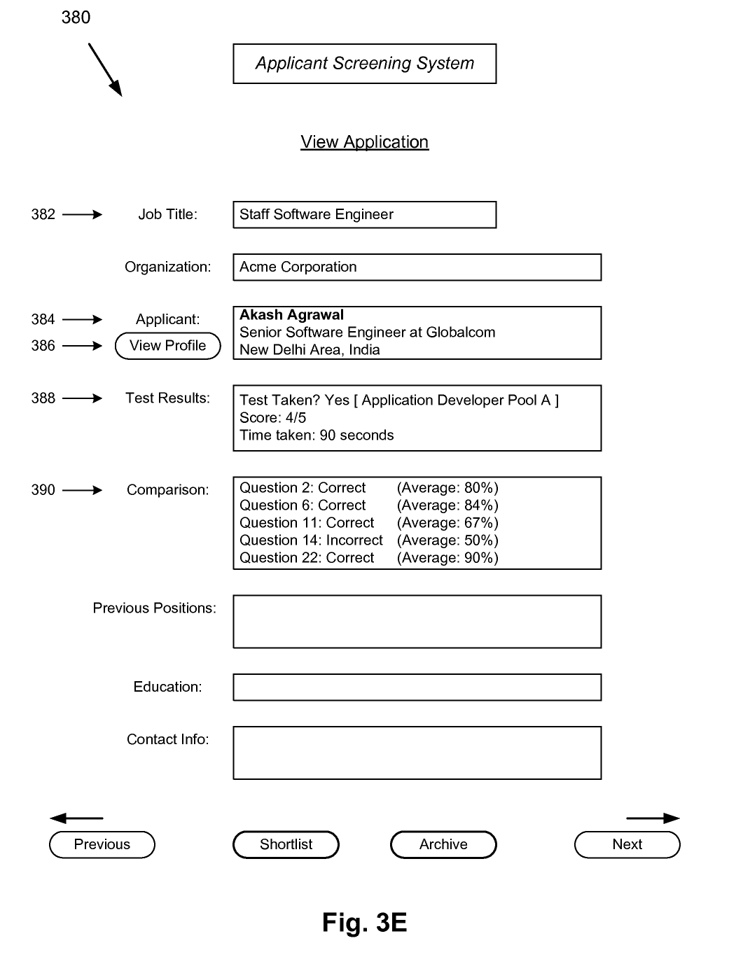

FIGS. 3A-B illustrate interfaces that may be employed by a recruiter or other organization representative to create and modify a pool of questions, according to some embodiments of the invention.

In FIG. 3A, a recruiter interacts with interface 300 to create a new pool of questions—possibly for a new functional area or domain, or possibly a new pool for an existing functional area or domain with different questions and/or levels of difficulties. A name for the pool is entered at 302, entry 304 receives a new question, and entry 306 allows the recruiter to enter answer options for the multiple-choice question; the correct answer is specified at 308, and the difficulty level of the question is entered at 310. If the question is to be short answer or fill-in-the-blank, the recruiter may enter a word phrase that the answer must contain. Interface 300 may differ in appearance when the recruiter enters a question having a format other than multiple choice; as shown, controls may be provide for identifying a type of question to add.

Until the recruiter finishes populating the pool with questions, he activates “Add Another Question” control 312 to start a new question, and selects the Save or Cancel option to close or abort the pool. In some implementations, recruiters are advised to include as many questions as possible in a pool so that the randomly drawn questions drawn for each applicant are usually unique. In some embodiments, questions may be suggested to a recruiter by the screening system or by an associated system.

For example, if the screening system is hosted by one entity for use by multiple other organizations wishing to accept applications through the applicant screening system, the entity hosting the system (e.g., LinkedIn® Corporation) may offer or suggest questions based on the domain or functional area of the pool, the position title, the job description, the organization using the system and/or other factors. Thus, the questions presented to an applicant for a position may originate with the organization that has the position available, and/or may be received from a third party.

Other controls and/or information may be included in interface 300 in other embodiments, such as an option to view the questions in the pool, delete a question, modify a question that was added, change the answer options, etc.

In FIG. 3B, a recruiter interacts with interface 320 to modify or amend pool of questions—to add a question, remove a question, edit a question (or answer), etc. At 322 he selects a pool to modify, and in portion 324 is able to scroll through the existing pool questions. Controls 326 allow him to edit a selected question, while control 328 allows him to create a new question. Other controls may be provided for removing a question, saving or canceling the modifications, etc.

FIG. 3C illustrates an interface that may be employed by a recruiter or other organization representative to define parameters of a position offered by the organization, according to some embodiments of the invention.

In FIG. 3C, a recruiter interacts with interface 340 to define a new or recurring position for which applications will be accepted and screened. At 342 he enters a name for the position (or may select one from a menu of existing choices), in entry 344 he identifies the organization that has the position available, and in portion 346 he selects a pool of questions from which to have a test created for an applicant. Among the options may be choices to not have a test or to create a new pool (and open interface 300 of FIG. 3A). There may be multiple pools for one functional area (e.g., with different difficulties, for different organizations, for different positions).

At 348 the recruiter specifies the number of questions to be presented to an applicant and at 350 selects the corresponding button to make the test mandatory or optional. At 352 he identifies the permissible range of difficulties from which the questions are to be selected. In some other implementations, the recruiter may be able to specify an exact number of questions to select at each of multiple levels of difficulty.

Other information may also be entered via interface 340, such as a location (or locations) of the position, a description of the organization and/or the responsibilities/duties of the position, desired skills/education/experience, languages, date of availability of the position, etc. The recruiter may activate corresponding controls to save the position, cancel its creation, create another position, view some or all positions that he has defined (and/or that other representatives have defined), etc.

FIG. 3D illustrates a testing interface that may be presented to a position applicant, according to some embodiments of the invention.

In FIG. 3D, an applicant is presented interface 360 during the process of applying for a position. The position being applied for, and to which the test corresponds, is identified at 362. An applicant may apply for multiple positions in one session or visit with the screening system, and some or all of them may have associated tests. In portion 364, the applicant scrolls through a list of questions (e.g., if there are more than one or two), and selects or enters her answers. Afterward she saves or submits her responses. Control 366 for skipping the test may or may not be enabled (or shown), depending on whether the recruiter who defined the position made the test optional or mandatory.

FIG. 3E illustrates an interface through which an applicant's test results may be reported to a recruiter or other organization representative, according to some embodiments of the invention.

In FIG. 3E, a recruiter interacts with interface 380 to view the application (or at least the test results) of an applicant for the position defined via interface 360 of FIG. 3C. The position is identified at 382, the applicant is identified at 384, and one or more controls may be offered (e.g., control 386) to view the applicant's profile on LinkedIn® Corporation or some other site or service. This profile may feature information that is not publicly accessible—i.e., information retained by the site that hosts the profile and that is not released to visitors (except possibly the applicant himself).

The applicant's test results are shown at 388, and in 390 the recruiter is able to see which questions the applicant was given, whether she answered each one correctly, and the average number of applicants who answered each of those questions. One or more controls may be provided to viewing any or all of the questions of the pool.

Other information may also be provided via interface 380, such as the location of the position, the organization that is hiring for the position, information about the applicant (e.g., current job, previous positions, education, how to contact her), documents uploaded by the applicant (e.g., résumé), etc. Controls are supplied to allow the recruiter to navigate to another applicant, to shortlist the current applicant, to archive her application (e.g., because she will not be considered further for position 382), to search for a particular applicant, etc.

Interfaces depicted in FIGS. 3A-E are exemplary and may differ to a small or large degree in other embodiments of the invention.

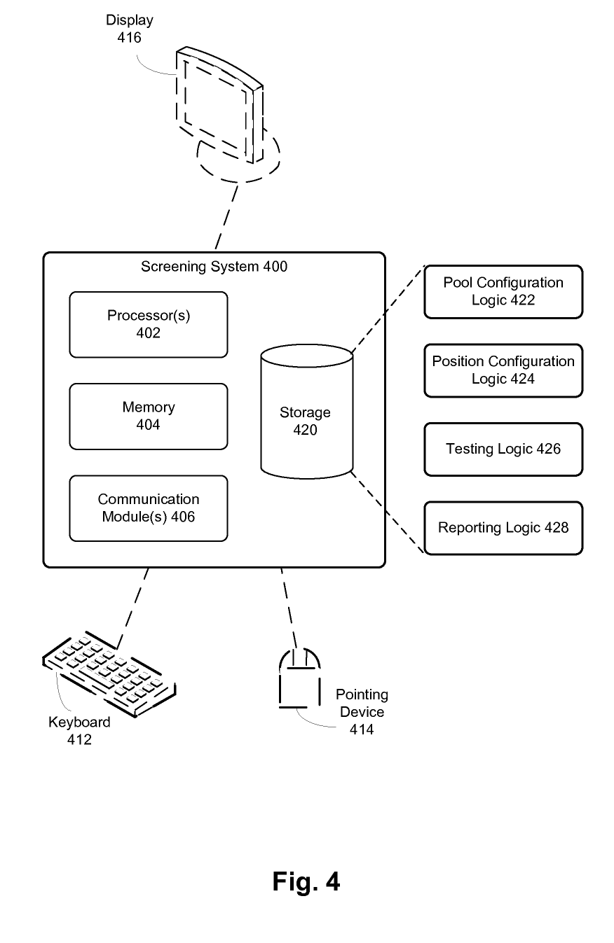

FIG. 4 is a block diagram of an apparatus for automatically screening an applicant, according to some embodiments of the invention.

Screening system 400 of FIG. 4 comprises processor(s) 402, memory 404, communication module(s) 406 and storage 420, which may comprise one or more optical, solid-state and/or magnetic storage components. Screening system 400 may be coupled (permanently or temporarily) to keyboard 412, pointing device 414 and display 416.

Memory 404 stores position descriptions, applicant attributes, applicant-provided information (e.g., résumés, applications), test questions, test responses, test results and other data during operation of system 400. Communication module(s) 406 may include communication interfaces for hosting either or both wired and wireless communication connections to and from system 400.

Storage 420 of the screening system stores content for serving to/for users, user data, tracking data and/or other information. Storage 420 also stores logic that may be loaded into memory 404 for execution by processor(s) 402. Such logic includes pool configuration logic 422, position configuration logic 424, testing logic 426, reporting logic 428 and/or other logic executed by the system during screening of applicants and applications. In other embodiments of the invention, any or all of these logic modules or other content may be combined or divided to aggregate or separate their functionality as desired.

Pool configuration logic 422 comprises processor-executable instructions for configuring pools of domain-specific questions. Pool configuration may include adding questions, removing questions, modifying questions, modifying possible responses, and/or other activity.

Position configuration logic 424 comprises processor-executable instructions for configuring a position for which applicants/applications will be screened via screening system 400. Position configuration may entail identifying the pools of questions (e.g., by functional area or domain) from which to assemble a test for an applicant, selecting a number and/or difficulty of questions for a test, making a test optional or mandatory, selecting specific questions to include or exclude, adding a question unique to the position (i.e., not for inclusion in the pool), etc.

Testing logic 426 comprises processor-executable instructions for administering a test to an applicant for a position. The testing logic may therefore select questions in accordance with parameters associated with the position, present them to the applicant (e.g., one at a time, all at once), receive the applicant's responses/answers, grade the applicant's responses, assemble results, etc.

Reporting logic 428 comprises processor-executable instructions for reporting results of an applicant's test, and possibly historical data from other applicants (e.g., averages, ranges).

In some embodiments of the invention, a screening system or apparatus depicted in FIG. 1 or FIG. 4 includes additional or fewer components. For example, additional components may be included and functionality described herein may be distributed among the new configuration. Alternatively, one or more components may be omitted and the functionality performed on the remaining components. Individual components (e.g., web server 112, application server 122, screening system 400) may be implemented as separate hardware entities (e.g., computer servers) or as virtual entities (e.g., software processes) operating on one or more computer servers.

An environment in which some embodiments of the invention are executed may incorporate a general-purpose computer or a special-purpose device such as a hand-held computer or communication device. Some details of such devices (e.g., processor, memory, data storage, display) may be omitted for the sake of clarity. A component such as a processor or memory to which one or more tasks or functions are attributed may be a general component temporarily configured to perform the specified task or function, or may be a specific component manufactured to perform the task or function. The term “processor” as used herein refers to one or more electronic circuits, devices, chips, processing cores and/or other components configured to process data and/or computer program code.

Data structures and program code described in this detailed description are typically stored on a non-transitory computer-readable storage medium, which may be any device or medium that can store code and/or data for use by a computer system. Non-transitory computer-readable storage media include, but are not limited to, volatile memory, non-volatile memory, magnetic and optical storage devices such as disk drives, magnetic tape, CDs (compact discs) and DVDs (digital versatile discs or digital video discs), solid-state drives and/or other non-transitory computer-readable media now known or later developed.

Methods and processes described in the detailed description can be embodied as code and/or data, which can be stored in a non-transitory computer-readable storage medium as described above. When a processor or computer system reads and executes the code and manipulates the data stored on the medium, the processor or computer system performs the methods and processes embodied as code and data structures and stored within the medium.

The foregoing descriptions of embodiments of the invention have been presented for purposes of illustration and description only. They are not intended to be exhaustive or to limit the invention to the forms disclosed. Accordingly, many modifications and variations will be apparent to practitioners skilled in the art. The scope of the invention is defined by the appended claims, not the preceding disclosure.

1. A method of screening an applicant for an employment position, the method comprising:
at an application-screening system, assembling a pool of questions regarding knowledge useful in a functional area associated with the employment position; and operating one or more processors of the application-screening system to:
receive an application for the employment position from an applicant;
prior to receipt of the application by a recruiter for the employment position, present to the applicant an automated test comprising one or more questions randomly drawn from the pool, wherein the number of questions in the automated test is less than the number of questions in the pool of questions;
provide an option for the applicant to not take the test; and
provide results of the test and application belonging to the applicant to the recruiter based on the applicant's selected option to take the test prior to providing the results of the test and the application to the recruiter based on the applicant's selected option to not take the test.

2. The method of claim 1, further comprising operating the one or more processors to:
determine a length of time required by the applicant to complete the test; and
report the length of time to the recruiter with the results of the test.

3. The method of claim 1, further comprising operating the one or more processors to:
report to the recruiter, for each question of the test:
whether the applicant answered the question correctly; and
of all applicants who received the question, a percentage of them who answered the question correctly.

4. The method of claim 1, further comprising operating the one or more processors to:
automatically add the applicant to a shortlist of candidates for the employment position if the results of the test exceed a threshold.

5. The method of claim 1, wherein presenting the applicant a test comprising one or more questions drawn from the pool comprises:
randomly selecting one or more questions from the pool based on parameters, if any, associated with the employment position.

6. The method of claim 5, wherein the parameters include one or more of:
a minimum number of questions to select; and
one or more difficulty levels of questions to select.

7. The method of claim 1, wherein assembling a pool of questions comprises:
for each of multiple functional areas, assembling a separate pool of questions for the functional area.

8. The method of claim 1, further comprising:
receiving from the recruiter parameters associated with the employment position, the parameters including one or more of:
a functional area of the employment position;
a minimum number of questions for the test;
one or more difficulty levels of questions to select for the test; and
whether the test is optional or required.

9. The method of claim 1, wherein providing results of the test comprises:
obtaining one or more attributes of the applicant;
cross-referencing the one or more attributes of the applicant with attributes of previous applicants; and
providing a comparison of the results of the test with results of tests taken by one or more of the previous applicants.

10. A computer-readable medium storing instructions that, when executed by a processor, cause the processor to perform a method of screening an applicant for an employment position, the method comprising:
at an automated application-screening system, assembling a pool of questions regarding knowledge useful in an employment position;
receiving an application for the employment position from an applicant;
prior to receipt of the application by a recruiter for the employment position, automatically presenting to the applicant a test comprising one or more questions randomly drawn from the pool, wherein the number of questions in the automated test is less than the number of questions in the pool of questions;
providing an option for the applicant to not take the test; and
providing results of the test and application belonging to the applicant to the recruiter based on the applicant's selected option to take the test prior to providing the results of the test and the application to recruiter based on the applicant's selected option to not take the test.

11. A system for screening an applicant for an employment position, the system comprising:
one or more processors; and
a memory configured to store instructions that, when executed by the one or more processors, cause the system to:
assemble a pool of questions regarding knowledge useful in a functional area associated with the employment position;
receive an application for the employment position from an applicant;
prior to receipt of the application by a recruiter for the employment position, present to the applicant an automated test comprising one or more questions randomly drawn from the pool, wherein the number of questions in the automated test is less than the number of questions in the pool of questions;
provide an option for the applicant to not take the test; and
provide results of the test and application belonging to the applicant to the recruiter based on the applicant's selected option to take the test prior to providing the results of the test and the application to the recruiter based on the applicant's selected option to not take the test.

12. The system of claim 11, wherein the memory is further configured to store instructions that, when executed by the one or more processors, cause the system to:
associate parameters with the employment position;
wherein the associated parameters affect configuration of the automated test.

13. The system of claim 11, wherein the memory is further configured to store instructions that, when executed by the one or more processors, cause the system to:
determine a length of time required by the applicant to complete the test; and
report the length of time to the recruiter with the results of the test.

14. The system of claim 11, wherein the memory is further configured to store instructions that, when executed by the one or more processors, cause the system to:
report to the recruiter, for each question of the test:
whether the applicant answered the question correctly; and
of all applicants who received the question, a percentage of them who answered the question correctly.

15. The system of claim 11, further comprising:
a data store storing multiple pools of questions, wherein each pool is associated with a different functional area and questions of the pool regard subject matter of the functional area.

16. The system of claim 11, wherein the memory is further configured to store instructions that, when executed by the one or more processors, cause the system to:
receive from the recruiter parameters associated with the employment position, the parameters including one or more of:
a functional area of the employment position;
a minimum number of questions for the test;
one or more difficulty levels of questions to select for the test; and
whether the test is optional or required.

17. The system of claim 11, wherein providing results of the test comprises:
obtaining one or more attributes of the applicant;
cross-referencing the one or more attributes of the applicant with attributes of previous applicants; and
providing a comparison of the results of the test with results of tests taken by one or more of the previous applicants.

18. The method of claim 1, wherein the number of questions assembled into a pool will be great enough to diminish the frequency with which the same set of questions will be posed to applicants for a given position.
